(19) United States
(12) Patent Application Publication
(10) Pub. No.: US 2018/0328210 A1
(43) Pub. Date: Nov. 15, 2018

(54) Super-Critical C02 Expander

(71) Applicant: Dresser-Rand Company, Olean, NY (US)

(72) Inventors: Randall W. Moll, Scio, NY (US); Silvano R. Saretto, Snoqualmie, WA (US); Peter Voorhees, Naples Township, NY (US); Richard J. Wiederien, Bellevue, WA (US)

(21) Appl. No.: 15/978,671

(22) Filed: May 14, 2018

Related U.S. Application Data
(60) Provisional application No. 62/506,337, filed on May 15, 2017.

(51) Int. Cl. F01D 11/02; F01D 25/16; F01D 25/26; F01D 25/12; F01K 25/10

(52) U.S. Cl. CPC F01D 11/025; F01D 25/162; F01D 25/168; F05D 2220/30; F01D 25/12; F01K 25/103; F01D 25/26

(57) ABSTRACT

An expander may include a longitudinal axis, an inner casing split horizontally along the longitudinal axis, an outer casing split horizontally along the longitudinal axis and spaced radially outward from and encompassing the inner casing. Each axial end of the outer casing may form a respective gland seal housing, and the outer casing and inner casing may define an exhaust chamber therebetween. A plurality of expansion stages including a rotor shaft may be disposed within the inner casing and configured to expand the working fluid received from a working fluid source. A plurality of seals may be disposed within each of the gland seal housings and mounted circumferentially about the rotor shaft. The plurality of seals may include an annular seal, a plurality of dynamically self-adjustable seals disposed outboard of the annular seal, and at least one dry gas seal disposed outboard of the plurality of dynamically self-adjustable seals.

This application claims benefit of the May 15, 2017 filing date of U.S. provisional application 62/506,337, which is incorporated by reference herein.

### STATEMENT OF GOVERNMENT INTEREST

This invention was made with government support under Government Contract No. DE-FE0025959 awarded by the U.S. Department of Energy. The government may have certain rights in the invention.

### BACKGROUND

Heat engines are used to convert heat or thermal energy into useful mechanical work and are often used in power generation plants. One example of a heat engine is an expander (e.g., a turbine) which is often rotatably coupled to a generator or other power converting device. As working fluids are expanded in the expander, the shaft connecting the expander and generator rotates and generates electricity in the generator.

Most power plant expanders are based on the Rankine or Brayton cycle and obtain high temperature/pressure working fluids through the combustion of coal, natural gas, oil, and/or nuclear fission. Typical working fluids for Brayton cycles include steam and organic fluids. Recently, however, due to perceived benefits in terms of hardware compactness, efficiency, heat transfer characteristics, etc., there has been considerable interest in using super-critical carbon dioxide (ScC02) as a working fluid for certain heat engine applications. Notable among such applications are nuclear, solar, and waste heat energy conversion cycles.

Many waste heat recovery schemes utilizing ScC02 as the working fluid have relatively high process temperatures/pressures. For example, in some applications the temperatures can approach or exceed 600° C. and the operating pressures can range from between about 1000 psia and about 4500 psia. Elevated operating pressures can potentially impose large axial thrusts on equipment rotors, which may damage accompanying bearing systems if not properly managed. In addition, elevated operating temperatures may also damage the rotating equipment and bearing systems of the expander via unmanaged thermal growth of one or more components of the expander.

What is needed, therefore, is a compact expander capable of processing working fluids, such as supercritical carbon dioxide, at elevated pressures and temperatures.

### BRIEF DESCRIPTION

Embodiments of the present disclosure may provide an expander. The expander may include a longitudinal axis, an inner casing, an outer casing, a plurality of inlets, a plurality of transfer tubes, a plurality of nozzles, a plurality of expansion stages, and a plurality of seals. The inner casing may extend along the longitudinal axis and may define at least in part an axial flow passage. The outer casing may extend along the longitudinal axis and may be spaced radially outward from and may encompass the inner casing. Each axial end of the outer casing may form a respective gland seal housing, and the outer casing and inner casing may define an exhaust chamber therebetween. The plurality of inlets may extend radially outward from the outer casing and may be configured to receive a working fluid from a working fluid source. The plurality of transfer tubes may extend radially between the inner casing and the outer casing. Each transfer tube fluidly may be coupled to a respective inlet. Each nozzle may fluidly couple a respective transfer tube with the axial flow passage. The plurality of expansion stages may include a rotor shaft disposed within the axial flow passage. The plurality of expansion stages may be configured to expand the working fluid received from the working fluid source. The plurality of seals may be disposed within each of the gland seal housings. The plurality of seals may include an annular seal mounted circumferentially about the rotor shaft, a first plurality of self-adjustable seals mounted circumferentially about the rotor shaft and disposed outboard of the annular seal, and at least one dry gas seal mounted circumferentially about the rotor shaft and disposed outboard of the first plurality of self-adjustable seals.

Embodiments of the present disclosure may further provide a method for operating an expander. The method may include receiving a working fluid in a plurality of inlets equally spaced and circumferentially disposed about a longitudinal axis of the expander. The method may also include expanding a working fluid in a plurality of expansion stages fluidly coupled to the plurality of inlets and disposed within an inner casing of the expander. The method may further include discharging an expanded working fluid through an outlet extending radially from an outer casing of the expander. The outer casing may be spaced radially outward from and may encompass the inner casing. Each axial end of the outer casing may form a respective gland seal housing, and the outer casing and inner casing may define an exhaust chamber therebetween. The method may also include preventing or substantially preventing the working fluid from leaking across the outer casing to an external environment. Preventing or substantially preventing the working fluid from leaking across the outer casing to the external environment may include disposing in series in each of the gland seal housings each of an annular seal, a first plurality of self-adjustable seals, and at least one dry gas seal circumferentially about a rotor shaft of the expander. Preventing or substantially preventing the working fluid from leaking across the outer casing to the external environment may also include injecting a process fluid into each of the gland seal housings via a first conduit disposed between the annular seal and the first plurality of self-adjustable seals, the process fluid being injected at a higher pressure than a pressure within the respective gland seal housing. Preventing or substantially preventing the working fluid from leaking across the outer casing to the external environment may further include removing at least a portion of the process fluid from the respective gland seal housing via a second conduit disposed between the first plurality of self-adjustable seals and the at least one dry gas seal.

Embodiments of the present disclosure may further provide an expander. The expander may include a longitudinal axis, an inner casing, an outer casing, a plurality of inlets, a plurality of transfer tubes, a plurality of nozzles, a plurality of expansion stages, a first plurality of seals, and a second plurality of seals. The inner casing may be split horizontally along the longitudinal axis and may define at least in part an axial flow passage. The outer casing may be split horizontally along the longitudinal axis and may be spaced radially outward from and may encompass the inner casing. Each axial end of the outer casing may form a respective gland seal housing, and the outer casing and inner casing may define an exhaust chamber therebetween. The plurality of inlets may be equally spaced and circumferentially disposed about the longitudinal axis of the expander and configured to receive a working fluid including carbon dioxide from a working fluid source. The plurality of transfer tubes may extend radially between the inner casing and the outer casing. Each transfer tube fluidly may be coupled to a respective inlet. Each nozzle may fluidly couple a respective transfer tube with the axial flow passage. The plurality of expansion stages may be disposed within the axial flow passage. The plurality of expansion stages may be configured to expand the working fluid received from the working fluid source. Each expansion stage may include a plurality of rotor blades mounted circumferentially about a rotor shaft. The first plurality of seals may be disposed within each of the gland seal housings. The first plurality of seals may include an annular seal mounted circumferentially about the rotor shaft, a first plurality of self-adjustable seals mounted circumferentially about the rotor shaft and disposed outboard of the annular seal, and at least one dry gas seal mounted circumferentially about the rotor shaft and disposed outboard of the first plurality of self-adjustable seals. The second plurality of seals may be disposed at an end portion of the inner casing and configured to prevent or substantially prevent a leakage of working fluid from the inner casing to the exhaust chamber. The second plurality of seals may include a second plurality of self-adjusting seals aligned in series and disposed circumferentially about the rotor shaft.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a side view of an exemplary expander according to one or more embodiments disclosed.

FIG. 2 illustrates an end view of the expander of FIG. 1.

FIG. 3 illustrates an isometric, cutaway view of the expander taken along line 3-3 of FIG. 2.

FIG. 4 illustrates an isometric view of the expander of FIG. 1 with a portion of the outer casing removed for clarity purposes, according to one or more embodiments.

FIG. 5 illustrates an isometric, cutaway view of a portion of the expander including an inlet fluidly coupled with a respective nozzle of the expander, according to one or more embodiments.

FIG. 6 illustrates an isometric, cutaway view of the plurality of inlets coupled to respective nozzles, where the inner casing has been omitted for clarity purposes, according to one or more embodiments.

FIG. 7 illustrates an isometric, cutaway view portion of the expander including a plurality of keys received in respective guides, according to one or more embodiments of the disclosure.

FIG. 8 illustrates an isometric, cutaway view of a portion of the non-drive end of the expander including a plurality of seals disposed in a gland seal housing of the outer casing, according to one or more embodiments of the disclosure.

FIG. 9 illustrates a flowchart of a method for operating an expander, according to one or more embodiments disclosed.

### DETAILED DESCRIPTION

It is to be understood that the following disclosure describes several exemplary embodiments for implementing different features, structures, or functions. Exemplary embodiments of components, arrangements, and configurations are described below to simplify the present disclosure; however, these exemplary embodiments are provided merely as examples and are not intended to limit the scope of the disclosure. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the disclosure, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

As used herein, the terms “fore” and “upstream,” on the one hand, and the terms “aft” and “downstream,” on the other hand, are used interchangeably and are intended to indicate positions and directions relative to the principal direction of gas flow over a turbomachine rotor blade airfoil. Thus as will be appreciated by those skilled in the art, in an expander the fore and upstream positions of a rotor and a rotor blade will be at a higher static pressure than the aft and downstream positions. In either case, however, there is a possibility for leakage flow to occur between adjacent blade platforms or between a cavity and flow path, and it is the minimization of such leakage flow to which one or more embodiments of the present disclosure is directed.

As used herein, the terms “upstream” and “downstream” are intended to indicate positions and directions relative to the principal direction of gas flow over an expander rotor blade airfoil. Thus as will be appreciated by those skilled in the art, in the expander the upstream positions of a rotor and a rotor blade will be at a higher static pressure than the downstream positions. Further, the terms “upper” and “lower” are intended to indicate positions and directions relative to the horizontal orientation of the expander.

As used herein, the term “substantially prevent” means to prevent to a measurable extent, but not necessarily to completely prevent.

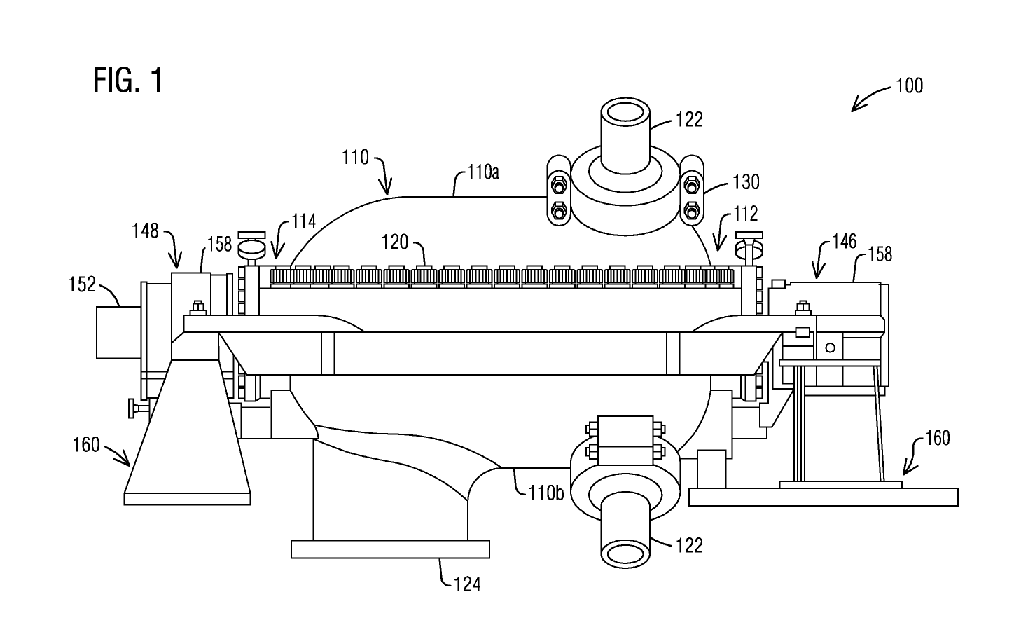

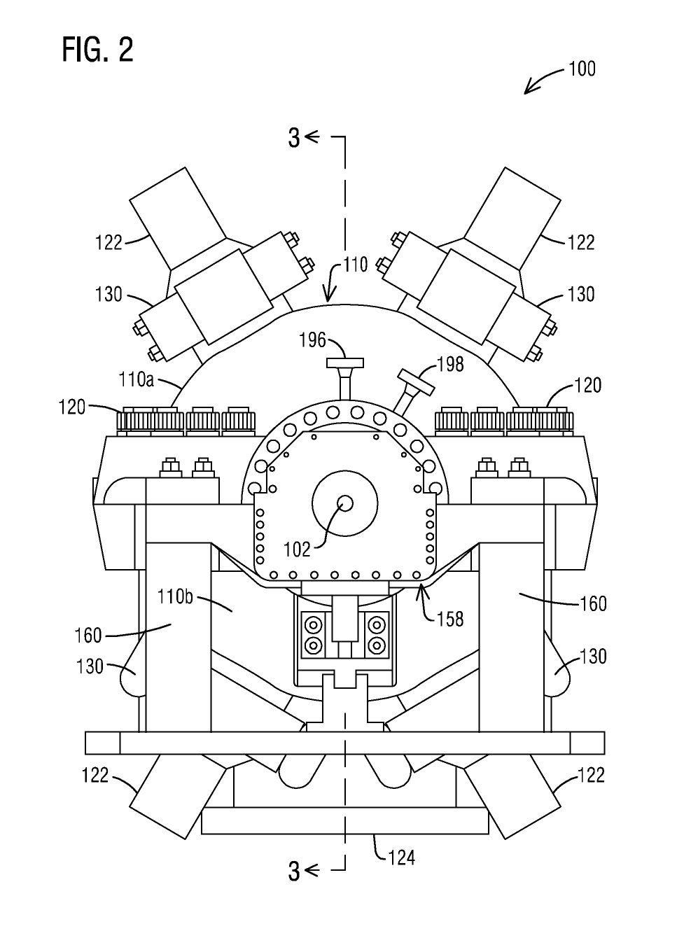

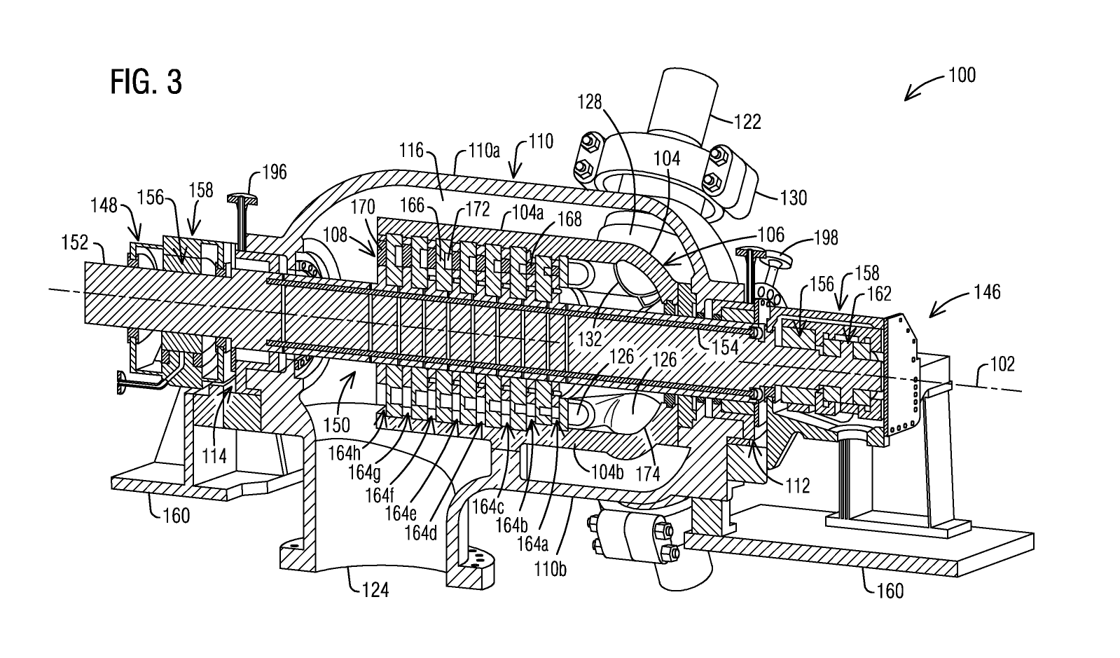

Turning now to the Figures, FIGS. 1 and 2 illustrate respective side and end views of an exemplary expander 100, according to one or more embodiments of the disclosure. FIG. 3 illustrates an isometric, cutaway view of the expander 100 taken along line 3-3 of FIG. 2. The expander 100 may be configured to drive a process component (not shown), such as, for example, a generator, and may be a component of a power plant (not shown) or like system. Other illustrative examples of driven process components may include, but are not limited to, pumps, mills, compressors, or other devices/systems configured to receive rotating shaft horsepower to do work.

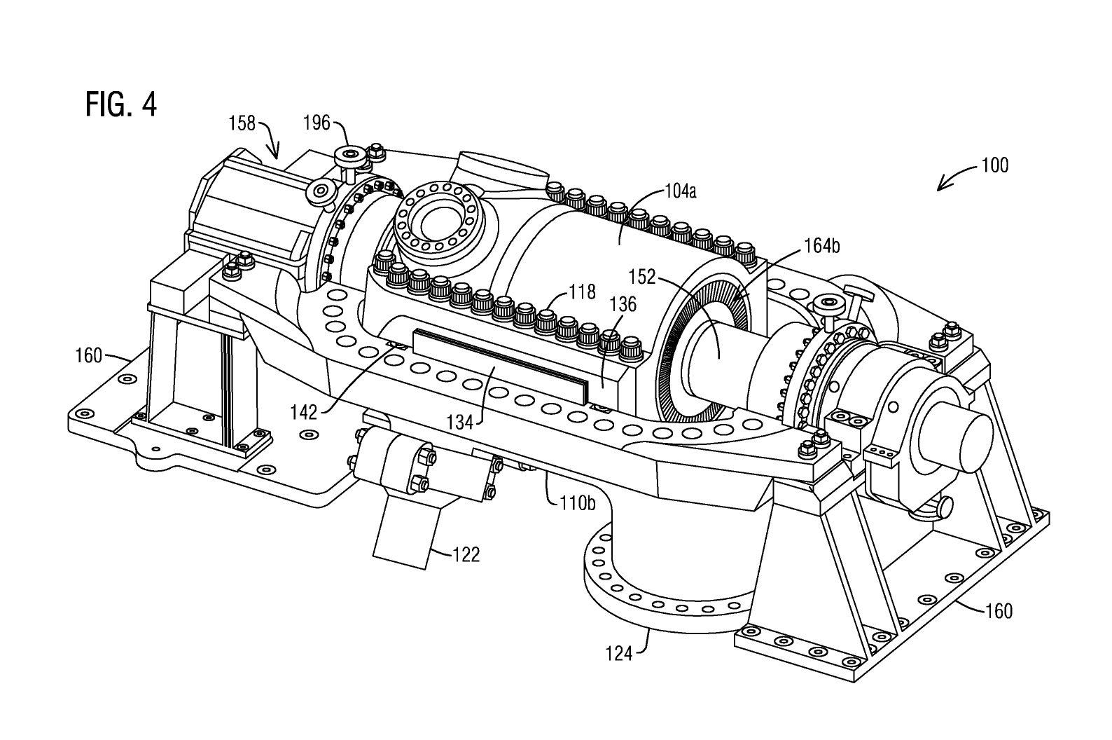

Referring now to FIG. 4 with continued reference to FIGS. 1-3, the expander 100 in operation may be substantially horizontally disposed along a longitudinal axis 102 thereof and may include an inner casing 104 having an inner casing inlet end portion 106 and an inner casing outlet end portion 108. The expander 100 may further include an outer casing 110 spaced radially outward from and encompassing the inner casing 104. The outer casing 110 may have an outer casing inlet end portion 112 and an outer casing outlet end portion 114. In one or more embodiments, each of the inner casing 104 and the outer casing 110 may be generally barrel-shaped. As arranged, a generally annular exhaust chamber 116 may be defined between the inner casing 104 and the outer casing 110.

Each of the inner casing 104 and the outer casing 110 may be cast from a high nickel alloy and horizontally split along the longitudinal axis 102 of the expander 100 to allow for more facile access to and maintenance of the expander 100. Accordingly, the inner casing 104 may be formed from an inner casing upper portion 104a and an inner casing lower portion 104b coupled with one another via a plurality of fasteners (one indicated 118). Likewise, the outer casing 110 may be formed from an outer casing upper portion 110a and an outer casing lower portion 110b coupled with one another via a plurality of fasteners (one indicated 120). As shown most clearly in FIG. 4, the plurality of fasteners 118 coupling the inner casing upper portion 104a and the inner casing lower portion 104b may be a series of threaded bolts. As shown most clearly in FIG. 1, the plurality of fasteners 120 coupling the outer casing upper portion 110a and the outer casing lower portion 110b may be a series of threaded bolts.

As illustrated in FIGS. 1-4, the expander 100 may be a radial-flow expander and may include a plurality of inlets (four shown 122) extending radially from the outer casing 110 and configured to receive a working fluid to be expanded. The expander 100 may also include an outlet 124 extending radially outward from the outer casing 110 and configured to discharge the expanded working from the expander 100. The term “working fluid” is not intended to limit the state or phase of the working fluid. Rather, the working fluid may be in a liquid phase, a gas phase, a super-critical phase, a sub-critical state, combinations thereof, or any other phase or state. In one embodiment, the working fluid may include steam or air. In other embodiments, the working fluid may be or include carbon dioxide (C02), such as super-critical carbon dioxide (ScC02). Carbon dioxide is a neutral working fluid that offers benefits such as non-toxicity, non-flammability, easy availability, low price, and no need of recycling. The term “carbon dioxide” is not intended to be limited to a C02 of any particular type, purity, or grade. For example, in at least one embodiment industrial-grade C02 may be used.

In other embodiments, the working fluid may be a binary, ternary, or other combination working fluid blend. The working fluid combination can be selected for the unique attributes possessed by the fluid combination within heat recovery systems. For instance, one such fluid combination includes a liquid absorbent and C02. In another embodiment, the working fluid may be a combination of C02 and one or more other miscible fluids or chemical compounds. In yet other embodiments, the working fluid may be a combination of C02 and propane, or C02 and ammonia, without departing from the scope of the disclosure.

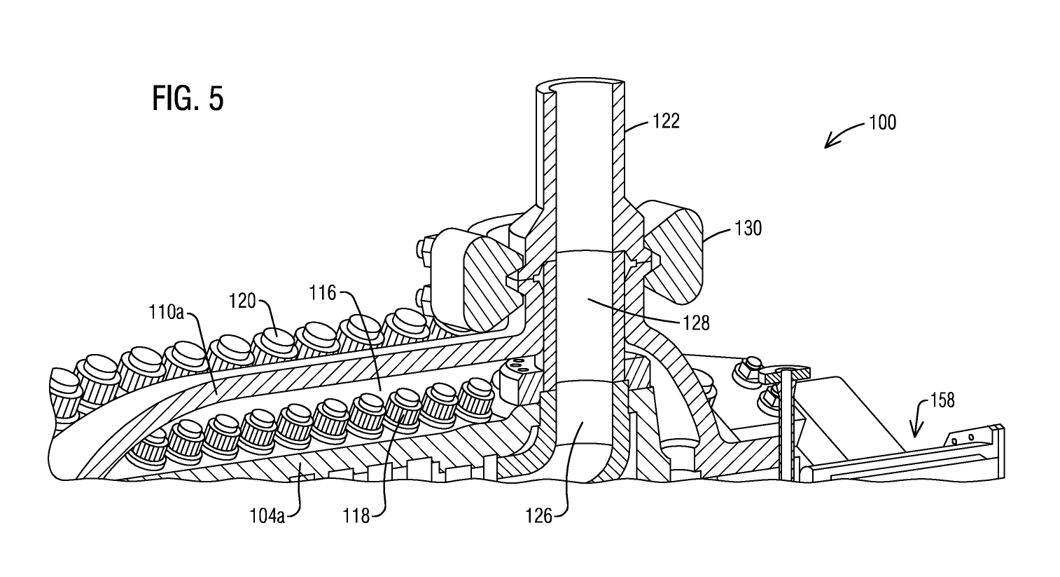

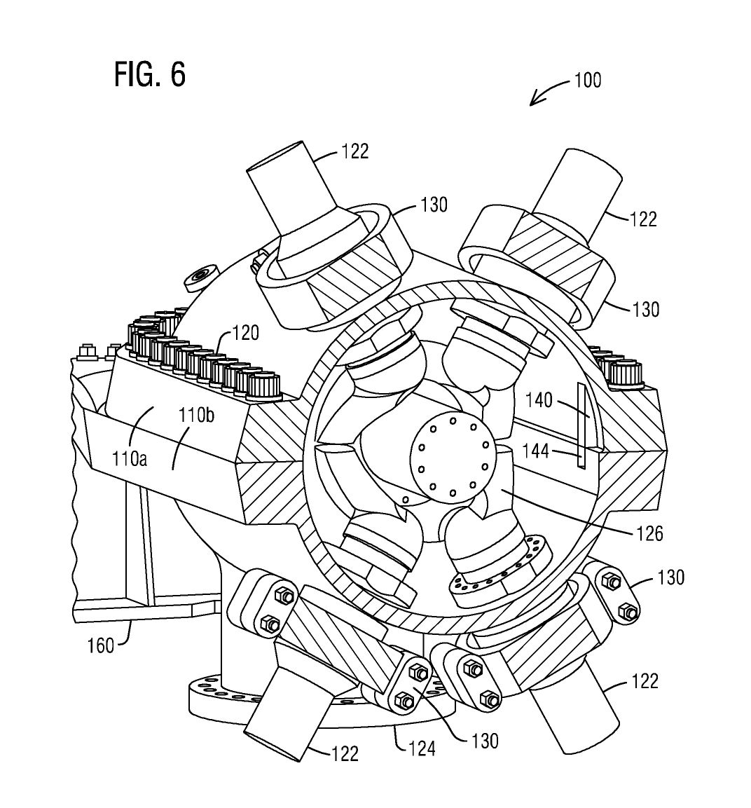

Referring now to FIGS. 5 and 6 with continued reference to FIGS. 1-4, FIG. 5 illustrates an isometric, cutaway view of a portion of the expander 100 depicting one inlet 122 of the plurality of inlets 122, according to one or more embodiments of the disclosure. FIG. 6 illustrates an isometric, cutaway view of the plurality of inlets 122 fluidly coupled to respective nozzles 126, where the inner casing 104 has been omitted for clarity purposes. The plurality of inlets 122 may be equidistantly spaced and circumferentially disposed about the longitudinal axis 102 of the expander 100. Each inlet 122 may be fluidly coupled to a supply line (not shown) supplying working fluid from a working fluid source (not shown), such as a storage tank or other upstream process component. Each inlet 122 may extend through respective openings defined by the outer casing inlet end portion 112 of the outer casing 110 and may be coupled with a respective transfer tube 128 extending between the outer casing 110 and the inner casing 104. Each transfer tube 128 may be coupled to the respective inlet 122 via a coupling 130. In one embodiment, the coupling 130 may be a GRAYLOC® connection manufactured by Oceaneering International, Inc. of Houston, Tex.

Each of the transfer tubes 128 may be coupled to a respective nozzle 126 extending though respective openings defined in the inner casing inlet end portion 106 of the inner casing 104. Each nozzle 126 may fluidly couple a respective inlet 122 with an axial flow passage 132 defined by the inner casing 104 and extending axially to the outlet 124 of the expander 100 at the inner casing outlet end portion 108. By positioning the plurality of inlets 122 circumferentially and equally spaced about the longitudinal axis 102 of the expander 100, a symmetric delivery of the working fluid may be provided to the axial flow passage 132, thereby minimizing gradients during thermal transients and maintaining alignment of the internal components of the expander 100.

As further illustrated in FIGS. 4 and 6, the inner casing 104 and the outer casing 110 may be configured to restrain the movement of the inner casing 104 in relation to the outer casing 110 to prevent misalignment and/or damage to the transfer tubes 128. The inner casing upper portion 104a may include an elongated bar 134 extending from an outer surface 136 of the inner casing upper portion 104a and configured to seat within and axially translate along a slot 138 formed in the outer casing lower portion 110b. Further, the outer casing upper portion 110a may form a boss 140 configured to restrain the elongated bar 134 and thus the inner casing 104 from upward vertical movement. In addition, the inner casing 104 may include a plurality of axial position lugs (one shown 142) extending from the inner casing upper portion 104a and configured to seat within respective pockets 144 defined in the outer casing lower portion 110b. The axial position lugs 142 may be configured to prevent axial movement of the inner casing inlet end portion 106 adjacent the transfer tubes 128, while permitting the inner casing outlet end portion 108 to expand axially. As configured, the inner casing 104 may be restrained from axial movement at the location of the transfer tubes 128, while allowing for axial movement of the inner casing 104 via thermal growth toward the inner casing outlet end portion 108.

As shown most clearly in FIG. 1, the expander 100 includes a non-drive end 146 and a drive end 148, and a rotor 150 that extends substantially between the two ends 146, 148. In one embodiment, the rotor 150 may include an integral, single-piece rotor shaft 152. In other embodiments, however, the rotor shaft 152 may be split and may include a plurality of rotor shaft segments coupled with one another via a plurality of fasteners 154, such as, for example, tie bolts. The rotor shaft 152 may be constructed from a combination of a high nickel alloy (e.g., Inconel 901) forgings and ASTM A470 alloy steel forgings. In one or more embodiments, the rotor shaft 152 may be supported at each end by one or more radial bearings 156 disposed in a bearing case 158. Each bearing case 158 may be supported by a flexible or rigid bearing case support 160. The bearing case supports 160 may be further connected to the outer casing 110 to further support the outer casing 110 while allowing free relative movement with temperature changes and maintaining alignment of the rotor 150. In one or more embodiments, each bearing case 158 may be constructed from ASTM A216, Grade WCB.

Each of the radial bearings 156 may be oil-lubricated, hydrodynamic journal bearings. In some embodiments, the radial bearings 156 may be magnetic bearings, such as active or passive magnetic bearings. In other embodiments, however, other types of radial bearings 156, such as gas bearings, may be used without departing from the scope of the disclosure. For example, the radial bearings 156 may be gas bearings utilizing a portion of the working fluid including carbon dioxide provided from a storage tank, a portion of the expander 100, or another process component. In addition, at least one axial thrust bearing 162 may be provided at or near the end of the rotor 150 adjacent the non-drive end 146 of the expander 100 in the bearing case 158. The axial thrust bearing 162 may be a magnetic bearing configured to bear at least a portion of the axial thrust generated by the expander 100. It will be appreciated, however, that the axial thrust bearing 162 may be arranged in other locations along the rotor 150, or omitted altogether, without departing from the scope of the disclosure. Each of the radial bearings 156 and the bearing case 158 may be axially split to facilitate assembly and maintenance thereof.

The expander 100, as shown in FIG. 1, includes eight axially-adjacent expansion stages 164a-h. It will be appreciated, however, that any number of expansion stages may be employed without departing from the scope of the disclosure. Each expansion stage 164a-h may include a plurality of non-rotating stator vanes (one indicated 166) followed axially by a plurality of rotating blades (one indicated 168) mounted on the outer radial extent of a disc-shaped wheel (one indicated 170). The wheel 170, in turn, may be mounted on the rotor shaft 152 or otherwise may form an integral part thereof, such that the rotor shaft 152, wheels 170, and blades 168 are collectively referred to as the rotor 150. Each expansion stage 164a-h may include a diaphragm disc 172 from which the plurality of non-rotating stator vanes 166 extend. The diaphragm discs 172 may be seated in respective annular grooves defined in an inner surface 174 of the inner casing 104. Each of the stator vanes 166 may be adjustable, such that the vertical and lateral alignment of the stator vanes 166 may be optimized for the rotor 150.

In one or more embodiments, one or more of the rotating blades 168 may be constructed from vacuum cast Inconel 738. In one or more embodiments, one or more of the wheels 170 may be constructed from a high nickel alloy (e.g., Inconel 901). In one or more embodiments, one or more of the diaphragm discs 172 may be constructed from precision investment casting FSX-414.

In operation, the working fluid enters the expander 100 via the plurality of inlets 122 and proceeds to the axial flow passage 132 via the plurality of nozzles 126 fluidly coupled to the plurality of inlets 122 via the transfer tubes 128. Each of the plurality of nozzles 126 may be configured to direct the working fluid to the first expansions stage 164a. The working fluid enters the first expansion stage 164a where the stator vanes 166 direct the working fluid into the axially-succeeding blades 168. As the working fluid contacts the blades 168, a rotating force is imparted, causing the rotor 150 to rotate. The partially-expanded working fluid in the first expansion stage 164a is then directed to the second through eight expansion stages 164b-h, successively, and the foregoing process is repeated in each expansion stage 164b-h. As the working fluid progresses through the expansion stages 164a-h from right to left, more rotational force is imparted to the rotor 150 and the pressure and temperature of the working fluid progressively decreases.

In at least one embodiment, one or more of the internal components of the expander 100 may be cooled with a portion of the working fluid directed circulating through or provided from another portion of the power plant. For example, the inner casing 104 or components of one or more of the expansion stages 164a-h (e.g., vanes 166 and/or blades 168) may be cooled from a portion of the working fluid stored in a storage tank (not shown). In another example, the inner casing 104 or components of one or more of the expansion stages 164a-h (e.g., vanes 166 and/or blades 168) may be cooled from a portion of the working fluid discharged from another process component (e.g., compressor, pump, or heat exchanger).

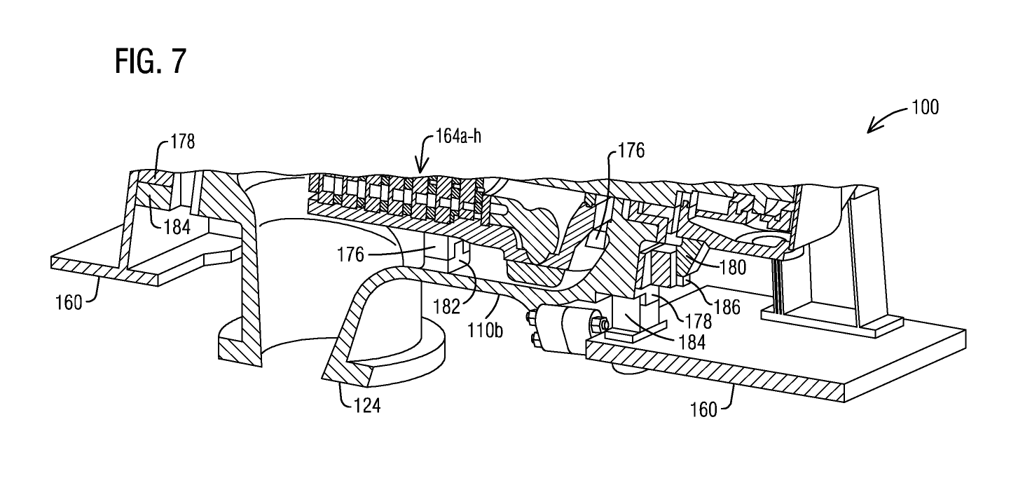

Referring now to FIG. 7 with continued reference to FIGS. 1-6, FIG. 7 illustrates a portion of the expander 100 including a plurality of keys 176, 178, 180 received in respective guides 182, 184, 186, according to one or more embodiments of the disclosure. Each of the paired keys 176, 178, 180 and guides 182, 184, 186 may be configured to maintain horizontal alignment of the rotor 150 during thermal growth of one or more components of the expander 100. To that end, the inner casing 104 of the expander 100 may include keys 176 disposed within the vertical plane of the longitudinal axis 102 of the expander 100. The keys 176 of the inner casing 104 may be mated with guides 182 connected to the outer casing 110 within the same vertical plane. The outer casing 110 of the expander 100 may also include keys 178 disposed within the vertical plane of the longitudinal axis 102 of the expander 100. The keys of the outer casing 110 may be mated with guides 184 connected to the bearing case supports 160 within the same vertical plane. In addition, the bearing case 158 may include a key 180 disposed within the vertical plane of the longitudinal axis 102 of the expander 100. The key 180 of the bearing case 158 may be mated with a guide 186 connected to the outer casing 110 within the same vertical plane. As arranged, the paired keys 176, 178, 180 and guides 182, 184, 186 may resist reasonable forces and moments imparted on the expander 100 by inlet and exhaust piping (not shown), while maintaining proper alignment with the driven process equipment.

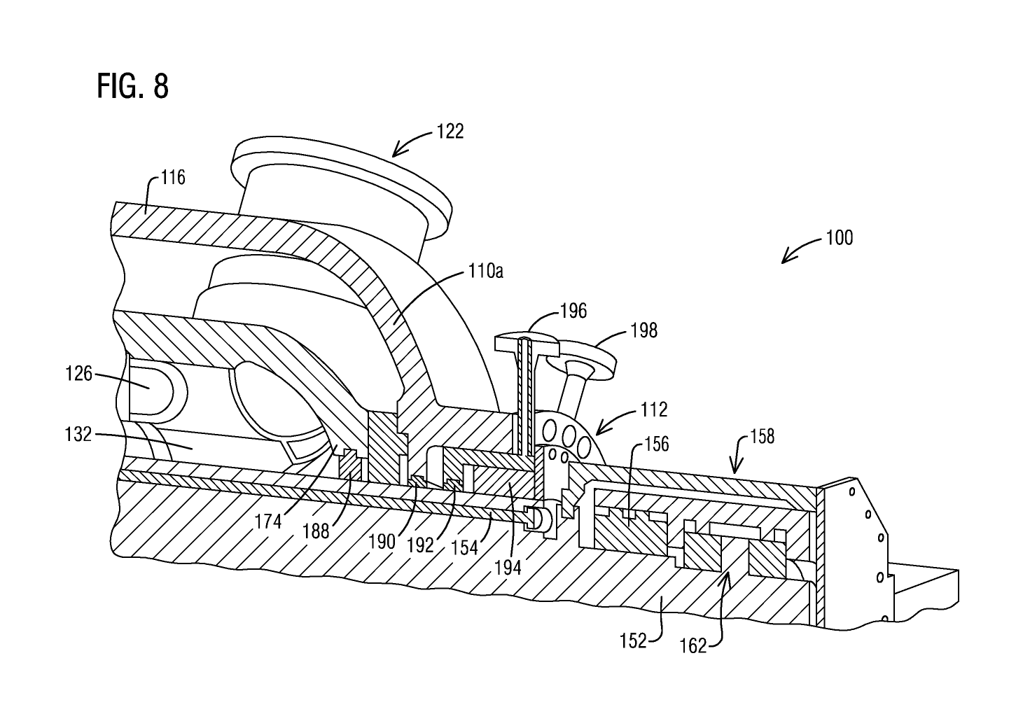

Referring now to FIG. 8 with continued reference to FIGS. 1-7, FIG. 8 illustrates an isometric, cross section view of a portion of the non-drive end of the expander 100 including a plurality of seals, according to one or more embodiments of the disclosure. The expander 100 may include a plurality of inner casing annular seals (three shown 188) adjustably mounted on the inner surface of the inner casing 104 at the inner casing inlet end portion 106 adjacent the non-drive end 146 of the expander 100. The inner casing annular seals 188 may be configured to prevent or substantially prevent a leakage flow of working fluid from a portion of the axial flow passage 132 adjacent the first expansion stage 164a to the exhaust chamber 116 of the outer casing 110. In one or more embodiments, the inner casing annular seals 188 may be non-contacting, self-adjusting dynamic seals. For example, at least one of the inner casing annular seals 188 may be a non-contacting, self-adjusting dynamic seal, such as a HALO™ seal manufactured by ATGI of Stuart, Fla. In some embodiments, each of the inner casing annular seals 188 may be non-contacting seals, self-adjusting dynamic seals, such as described above, e.g., HALO™ seals.

Without limiting disclosed embodiments to any theoretical principle of operation, a non-contacting seal, self-adjusting dynamic seal, such as the foregoing HALO™ seal, takes advantage of variation in hydrostatic pressures with seal tooth clearance (e.g., forming a hydrodynamic wedge separating seal from rotor (thus, non-contacting)) to develop a force balanced operational clearance as tight as a few thousandth of an inch (hundredths of a millimeter) over the rotor. The acceleration of fluid between the seal and the rotor creates a low-pressure region that draws the seal towards the rotor. As the seal approaches the rotor surface, the velocity of the fluid decreases, resulting in a pressure rise that increases the outward force on the seal. The operational clearance is achieved when this outward force is balanced with the inward force from the upstream and downstream pressures acting on the backside of the seal. Seal dimensions may be appropriately tuned to achieve the desired operational clearance for a given application. This seal can be effectively set for any desired clearance gap, and can further effectively accommodate both rotor off-set and run-out variation in real-time during operation.

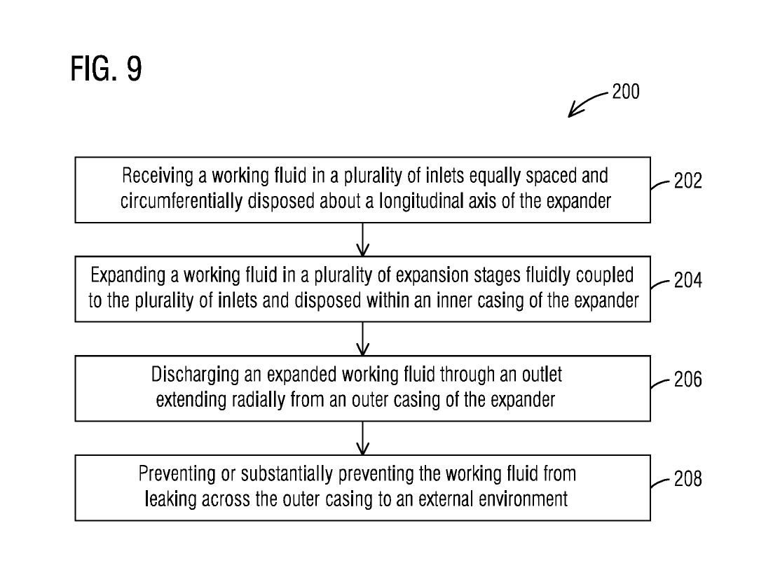

As seem most clearly in FIGS. 6 and 9, each of the outer casing inlet end portion 112 and the outer casing outlet end portion 114 of the outer casing 110 may be or include a gland seal housing. Each gland seal housing may include a plurality of seals 190, 192, 194 disposed in series and varying in construction. In the illustrated embodiment, each gland seal housing may include an outer casing annular seal 190 illustrated as a labyrinth seal, a plurality of self-adjusting seals (two shown as HALO™ seals 192) disposed outboard of the outer casing annular seal 190, and at least one dry gas seal (two shown 194) mounted outboard of the plurality of self-adjusting seals 192. In another embodiment, the outer casing annular seal 190 shown as a labyrinth seal in FIGS. 6 and 9 may be replaced with a HALO™ seal. In yet another embodiment, a single dry gas seal may replace the illustrated tandem dry gas seal 194.

Each of the seals 188, 190, 192, 194 may be mounted in the expander 100 via a seal carrier or other means known in the art. In one or more embodiments, the plurality of self-adjusting seals 192 may be disposed outboard of the outboard casing annular seal 190 and adjacent a balance piston configured to counter the axial thrust generated by the plurality of expansion stages 164a-h. The gland seal housing may further include an inlet process fluid conduit 196 and an outlet process fluid conduit 198 configured to cool the bearings 156, 162 and rotor shaft 152 and to purge any working fluid leaking from the inner casing 104.

In one embodiment, the inlet process fluid conduit 196 may extend between the outer casing annular seal 190 and the plurality of self-adjusting seals 192 and may be fluidly coupled to a process fluid source (not shown). In one or more embodiments, the process fluid source may be a storage tank, an expansion stage 164a-h of the expander 100, or another process component. The process fluid may be supercritical carbon dioxide, according to one or more embodiments of the disclosure.

The inlet process fluid conduit 196 may be injected at a higher pressure than the leakage flow of the working fluid from the inner casing 104 such that the process fluid seals against the flow of leakage flow across the outer casing annular seal 190. Further, the injected process fluid may travel outboard across the self-adjusting seals 192, thereby preventing any lubricant (e.g., oil) for the radial bearings 156 from entering the inner casing 104. The outlet process fluid conduit 198, in one or more embodiments, may be disposed between the self-adjusting seals 192 and the dry gas seal(s) 194. Accordingly, the process fluid flowing across the self-adjusting seals 192 is directed through the outlet process fluid conduit 198 in addition to any lubricant from the bearing case 158 and may be redirected to the process fluid source and filtered as needed before being further processed. In addition to the location of the seals 190, 192, 194 within the gland seal housing, one of ordinary skill in the art will appreciate that one or more of the seals 190, 192, 194 may be disposed within the expander 100 at other locations along the rotor 150 typically known in the art to benefit from the prevention of working fluid leakage therefrom.

Referring now to FIG. 9, FIG. 9 illustrates a flowchart of a method 200 for operating an expander, according to one or more embodiments disclosed. The method 200 may include receiving a working fluid in a plurality of inlets equally spaced and circumferentially disposed about a longitudinal axis of the expander, as at 202. The method 200 may also include expanding a working fluid in a plurality of expansion stages fluidly coupled to the plurality of inlets and disposed within an inner casing of the expander, as at 204. The method 200 may further include discharging an expanded working fluid through an outlet extending radially from an outer casing of the expander, as at 206. The outer casing may be spaced radially outward from and encompass the inner casing. Each axial end of the outer casing may form a respective gland seal housing, and the outer casing and inner casing may define an exhaust chamber therebetween.

The method may also include preventing or substantially preventing the working fluid from leaking across the outer casing to an external environment, as at 208. Preventing or substantially preventing the working fluid from leaking across the outer casing to an external environment may include disposing in series in each of the gland seal housings each of an annular seal, a first plurality of self-adjustable seals, and at least one dry gas seal circumferentially about a rotor shaft of the expander. Preventing or substantially preventing the working fluid from leaking across the outer casing to an external environment may also include injecting a process fluid into each of the gland seal housings via a first conduit disposed between the annular seal and the first plurality of self-adjustable seals. The process fluid may be injected at a higher pressure than a pressure within the respective gland seal housing. Preventing or substantially preventing the working fluid from leaking across the outer casing to an external environment may further include removing at least a portion of the process fluid from the respective gland seal housing via a second conduit disposed between the first plurality of self-adjustable seals and the at least one dry gas seal.

In the method 200, the annular seal may be a labyrinth seal, and the first plurality of self-adjustable seals may be HALO™ seals. In another embodiment, each of the annular seal and the first plurality of self-adjustable seals may be HALO™ seals. In the method 200, the working fluid may include supercritical carbon dioxide.

It should be appreciated that all numerical values and ranges disclosed herein are approximate valves and ranges, whether “about” is used in conjunction therewith. It should also be appreciated that the term “about,” as used herein, in conjunction with a numeral refers to a value that is +/−5% (inclusive) of that numeral, +/−10% (inclusive) of that numeral, or +/−15% (inclusive) of that numeral. It should further be appreciated that when a numerical range is disclosed herein, any numerical value falling within the range is also specifically disclosed.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions and alterations herein without departing from the scope of the present disclosure.

It is claimed:

1. An expander, comprising:
a longitudinal axis;
an inner casing extending along the longitudinal axis and defining at least in part an axial flow passage;
an outer casing extending along the longitudinal axis and spaced radially outward from and encompassing the inner casing, each axial end of the outer casing forming a respective gland seal housing, and the outer casing and inner casing defining an exhaust chamber therebetween;
a plurality of inlets extending radially outward from the outer casing and configured to receive a working fluid from a working fluid source;
a plurality of transfer tubes extending radially between the inner casing and the outer casing, each transfer tube fluidly coupled to a respective inlet;
a plurality of nozzles, each nozzle fluidly coupling a respective transfer tube with the axial flow passage;
a plurality of expansion stages including a rotor shaft disposed within the axial flow passage, the plurality of expansion stages configured to expand the working fluid received from the working fluid source; and
a plurality of seals disposed within each of the gland seal housings, the plurality of seals comprising
an annular seal mounted circumferentially about the rotor shaft;
a first plurality of dynamically self-adjustable seals mounted circumferentially about the rotor shaft and disposed outboard of the annular seal; and
at least one dry gas seal mounted circumferentially about the rotor shaft and disposed outboard of the first plurality of dynamically self-adjustable seals.

2. The expander of claim 1, wherein each gland seal housing further comprises
a first conduit disposed between the annular seal and the first plurality of dynamically self-adjustable seals and configured to inject a process fluid into the gland seal housing to prevent or
substantially prevent leakage of the working fluid from the outer casing and to cool the rotor shaft; and
a second conduit disposed between the first plurality of dynamically self-adjustable seals and the at least one dry gas seal and configured to remove at least the process fluid injected into the gland seal housing.

3. The expander of claim 1, wherein:
the annular seal is a labyrinth seal; and
the first plurality of dynamically self-adjustable seals comprise non-contacting seals relative to the rotor shaft.

4. The expander of claim 1, wherein each of the annular seal and the first plurality of dynamically self-adjustable seals comprise non-contacting seals relative to the rotor shaft.

5. The expander of claim 1, wherein:
the inner casing is split horizontally along the longitudinal axis and includes an inner casing upper portion and an inner casing lower portion; and
the outer casing is split horizontally along the longitudinal axis and includes an outer casing upper portion and an outer casing lower portion.

6. The expander of claim 5, wherein:
the inner casing upper portion includes an elongated bar extending from an outer surface thereof;
the outer casing lower portion defines a slot configured to receive therein the elongated bar of the inner casing upper portion and to allow for thermal growth of the inner casing in an axial direction;
the outer casing upper portion forms a boss configured to restrain the elongated bar and the inner casing upper portion from upward, vertical movement; and
the inner casing further includes a plurality of axial lugs extending from the inner casing upper portion and configured to seat within respective pockets defined in the outer casing lower portion, such that the axial position lugs are configured to prevent axial movement of an end portion of the inner casing adjacent the plurality of transfer tubes.

7. The expander of claim 5, wherein a second plurality of dynamically self-adjustable seals are mounted circumferentially about the rotor shaft at the end portion of the inner casing adjacent the plurality of transfer tubes and configured to prevent the leakage of the working fluid from the axial flow passage to the exhaust chamber.

8. The expander of claim 5, wherein the working fluid includes supercritical carbon dioxide.

9. The expander of claim 1, further comprising:
a first bearing case disposed at one axial end of the rotor shaft;
a second bearing case disposed at the other axial end of the bearing case, the first bearing case and the second bearing case each including at least one radial bearing;
an axial thrust bearing disposed within at least one of the first bearing case and the second bearing case;
a first bearing case support configured to support the first bearing case and a portion of the outer casing; and
a second bearing case support configured to support the second bearing case and another portion of the outer casing.

10. The expander of claim 1, further comprising:
a plurality of inner casing keys, each inner casing key disposed in a vertical plane including the longitudinal axis;
a plurality of inner casing guides, each inner casing guide disposed in the vertical plane including the longitudinal axis and receiving a respective inner casing key to form a paired inner casing key and guide, each paired inner casing key and guide configured to maintain horizontal alignment of the rotor shaft within the axial flow passage;
a plurality of outer casing keys, each outer casing key disposed in the vertical plane including the longitudinal axis;
a plurality of outer casing guides, each outer casing guide disposed in the vertical plane including the longitudinal axis and receiving a respective outer casing key to form a paired outer casing key and guide, each paired outer casing key and guide configured to maintain horizontal alignment of the rotor shaft within the axial flow passage;
a bearing case key disposed in the vertical plane including the longitudinal axis; and
a bearing case guide receiving the bearing case key to form a paired bearing case key and guide configured to maintain horizontal alignment of the rotor shaft within the axial flow passage.

11. The expander of claim 1, wherein the plurality of expansion stages includes eight axially-adjacent expansion stages, each expansion stage further comprising:
a plurality of non-rotating stator vanes extending from a diaphragm disc disposed within an annular groove of an inner surface of the inner casing;
a plurality of rotating blades mounted on an outer radial extent of a disc-shaped wheel, the disk-shaped wheel being mounted on the rotor shaft and disposed downstream from the diaphragm disc.

12. The expander of claim 1, wherein the plurality of transfer tubes are equally spaced and circumferentially disposed about the longitudinal axis of the expander.

13. A method for operating an expander, comprising:
receiving a working fluid in a plurality of inlets equally spaced and circumferentially disposed about a longitudinal axis of the expander;
expanding a working fluid in a plurality of expansion stages fluidly coupled to the plurality of inlets and disposed within an inner casing of the expander;
discharging an expanded working fluid through an outlet extending radially from an outer casing of the expander, the outer casing spaced radially outward from and encompassing the inner casing, each axial end of the outer casing forming a respective gland seal housing, and the outer casing and inner casing defining an exhaust chamber therebetween;
preventing or substantially preventing the working fluid from leaking across the outer casing to an external environment, wherein preventing or substantially preventing the working fluid from leaking across the outer casing to the external environment comprises
disposing in series in each of the gland seal housings each of an annular seal, a first plurality of dynamically self-adjustable seals, and at least one dry gas seal circumferentially about a rotor shaft of the expander; and
injecting a process fluid into each of the gland seal housings via a first conduit disposed between the annular seal and the first plurality of dynamically self-adjustable seals, the process fluid being injected at a higher pressure than a pressure within the respective gland seal housing; and
removing at least a portion of the process fluid from the respective gland seal housing via a second conduit disposed between the first plurality of dynamically self-adjustable seals and the at least one dry gas seal.

14. The method of claim 13, wherein:
the annular seal is a labyrinth seal; and
the first plurality of dynamically self-adjustable seals comprise non-contacting seals relative to the rotor shaft.

15. The method of claim 13, wherein each of the annular seal and the first plurality of dynamically self-adjustable seals comprise non-contactive seals relative to the rotor shaft.

16. The method of claim 13, wherein the working fluid includes supercritical carbon dioxide.

17. The method of claim 13, wherein preventing or substantially preventing the working fluid from leaking across the outer casing to the external environment further comprises:
disposing in series a second plurality of self-adjustable seals circumferentially about a rotor shaft of the expander at an inner casing inlet end portion.

18. An expander, comprising:
a longitudinal axis;
an inner casing split horizontally along the longitudinal axis and defining at least in part an axial flow passage;
an outer casing split horizontally along the longitudinal axis and spaced radially outward from and encompassing the inner casing, each axial end of the outer casing forming a respective gland seal housing, and the outer casing and inner casing defining an exhaust chamber therebetween;
a plurality of inlets equally spaced and circumferentially disposed about the longitudinal axis of the expander and configured to receive a working fluid including carbon dioxide from a working fluid source;
a plurality of transfer tubes extending radially between the inner casing and the outer casing, each transfer tube fluidly coupled to a respective inlet;
a plurality of nozzles, each nozzle fluidly coupling a respective transfer tube with the axial flow passage;
a plurality of expansion stages disposed within the axial flow passage, the plurality of expansion stages configured to expand the working fluid receive d from the working fluid source, and each expansion stage including a plurality of rotor blades mounted circumferentially about a rotor shaft;
a first plurality of seals disposed within each of the gland seal housings, the first plurality of seals comprising
an annular seal mounted circumferentially about the rotor shaft;
a first plurality of dynamically self-adjustable seals mounted circumferentially about the rotor shaft and disposed outboard of the annular seal; and
at least one dry gas seal mounted circumferentially about the rotor shaft and disposed outboard of the first plurality of dynamically self-adjustable seals; and
a second plurality of seals disposed at an end portion of the inner casing and configured to prevent or substantially prevent a leakage of working fluid from the inner casing to the exhaust chamber, the second plurality of seals comprising a second plurality of dynamically self-adjusting seals aligned in series and disposed circumferentially about the rotor shaft.

19. The expander of claim 18, wherein:
the annular seal is a labyrinth seal; and
the first plurality of dynamically self-adjustable seals and the second plurality of dynamically self-adjustable seals comprise non-contacting seals relative to the rotor shaft.

20. The expander of claim 19, wherein:
the inner casing includes an inner casing upper portion and an inner casing lower portion;
the outer casing includes an outer casing upper portion and an outer casing lower portion;
the inner casing upper portion includes an elongated bar extending from an outer surface thereof;
the outer casing lower portion defines a slot configured to receive therein the elongated bar of the inner casing upper portion and to allow for thermal growth of the inner casing in an axial direction;
the outer casing upper portion forms a boss configured to restrain the elongated bar and the inner casing upper portion from upward, vertical movement; and
the inner casing further includes a plurality of axial lugs extending from the inner casing upper portion and configured to seat within respective pockets defined in the outer casing lower portion, such that the axial position lugs are configured to prevent axial movement of the end portion of the inner casing adjacent the plurality of transfer tubes.
